(19) United States
(12) Patent Application Publication
(10) Pub. No.: US 2016/0027411 A1
(43) Pub. Date: Jan. 28, 2016

(54) DISPLAY DRIVING CIRCUIT

(71) Applicant: GIANTPLUS TECHNOLOGY CO., LTD., MIAO-LI COUNTY (TW)

(72) Inventor: YU-YEN LIN, MIAO-LI COUNTY (TW)

(21) Appl. No.: 14/537,010

(22) Filed: Nov. 10, 2014

(30) Foreign Application Priority Data
Jul. 22, 2014 (TW) 103125194

(51) Int. Cl. G09G 5/18

(52) U.S. Cl. CPC G09G 5/18; G09G 2330/021

(57) ABSTRACT

The present invention relates to a display driving circuit, which comprises a power circuit, a data driving circuit, a common driving circuit, and a scan driving circuit. The power circuit generates a power signal. The data driving circuit is coupled to the power circuit, and outputs a plurality of data signals to a plurality of pixels, respectively, according to the power signal or a reference signal. The common driving circuit is coupled to the power circuit, and outputs a common signal to the pixels according to the power signal or the reference signal. The scan driving circuit controls the pixels to receive the data signals, respectively, for displaying a frame.

### FIELD OF THE INVENTION

The present invention relates generally to a display driving circuit, and particularly to a power-saving display driving circuit.

### BACKGROUND OF THE INVENTION

Presently, displays are applied extensively to various electronic products or household appliances. With the advancement of technologies and rising of environmental consciousness, power saving is an important direction in current designs. Nonetheless, in order to control displaying of a plurality of pixels, a general display needs to include a source driving circuit, a common driving circuit, and agate driving circuit, which output signals with different levels, respectively, for controlling displaying of the plurality of pixels. For example, when a general display controls a plurality of pixels, five types of power sources are generated for driving the displaying of the plurality of pixels. Hence, at any time after a display is turned on, the driving circuits need to generate five types of power sources for driving the displaying the plurality of pixels.

Compare with the displays according to the prior art consume massive power, the display according to the present invention is more power saving and thus more advantageous.

### SUMMARY

An objective of the present invention is provide a display driving circuit, which reduces the required power and thus achieving the purpose of saving power.

In order to achieve the objective described above, the display driving circuit according to the present invention comprises a power circuit, a data driving circuit, a common driving circuit, and a scan driving circuit. The power circuit generates a power signal. The data driving circuit is coupled to the power circuit, and outputs a plurality of data signals to a plurality of pixels, respectively, according to the power signal or a reference signal. The common driving circuit is coupled to the power circuit, and outputs a common signal to the pixels according to the power signal or the reference signal. The scan driving circuit controls the pixels to receive the data signals, respectively, for displaying a frame.

### BRIEF DESCRIPTION OF THE DRAWINGS

FIG. 1 shows a block diagram of the display driving circuit according to an embodiment of the present invention;

FIG. 2 shows a block diagram of the data selecting circuit, the common selecting circuit, and the scan selecting circuit according an embodiment of the present invention;

FIG. 3 shows the first waveforms of the data signal and the common signal according to the present invention; and

FIG. 4 shows the second waveforms of the data signal and the common signal according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

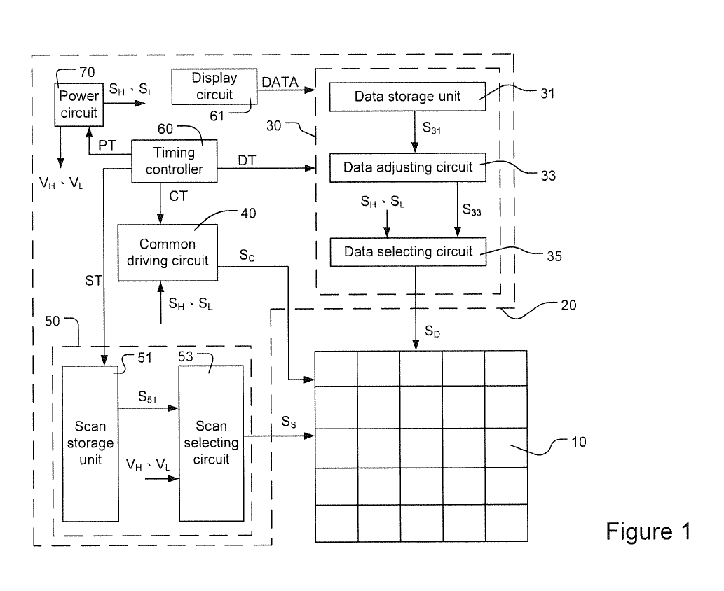

Please refer to FIG. 1, which shows a block diagram of the display driving circuit 20 according to an embodiment of the present invention. As shown in the figure, the display driving circuit 20 according to the present invention comprises a power circuit 70, a data driving circuit 30, a common driving circuit 40, and a scan driving circuit 50. The power circuit 70 generates a power signal S_{H}. The data driving circuit 30 is coupled to the power circuit 70, and outputs a plurality of data signals S_{D} to a plurality of pixels 10, respectively, according to the power signal S_{H} or a reference signal S_{L}. The common driving circuit 40 is coupled to the power circuit 70, and outputs a common signal S_{C} to the pixels 10 according to the power signal S_{H} or the reference signal S_{L}. The scan driving circuit 50 controls the pixels 10 to receive the data signals S_{D}, respectively, for displaying a frame.

Please refer to FIG. 1 again. The display driving circuit 20 according to the present invention further comprises a timing controller 60, which is coupled to the pixels 10 for driving them. In addition, the timing controller 60 is used in controlling the operating timing of the power circuit 70, the data driving circuit 30, the common driving circuit 40, and the scan driving circuit 50. Thereby, the timing controller 60 outputs a data timing signal DT to the data driving circuit 30, a common timing signal CT to the common driving circuit 40, a scan timing signal ST to the scan driving circuit 50, and a power timing signal PT to the power circuit 70, respectively, for controlling timely operations of the data driving circuit 30, the common driving circuit 40, the scan driving circuit 50, and the power circuit 70 and thus displaying frames normally.

The data driving circuit 30 is coupled to the pixels 10 for driving them. Besides, the data driving circuit 30 comprises a data storage unit 31, a data adjusting circuit 33, and a data selecting circuit 35. The data storage unit 31 is coupled to the timing controller 60 and receives the data timing signal DT. The data timing signal DT controls the data storage unit 31 to start storing a display data DATA. The data storage unit 31 then generates a data control signal S₃₁ according to the display data DATA. In other words, the data storage unit 31 is coupled to the timing controller 60 and stores the display data DATA according to the data timing signal DT for generating the data control signal S₃₁. The display data DATA is provided by a display circuit 61 or an external circuit and stored in the data storage unit 31. The present invention does not limit which circuit to provide the display data DATA. The data adjusting circuit 33 is coupled to the data storage unit 31 and receives the data control signal S₃₁. After the data adjusting circuit 33 adjusts the data control signal S₃₁, the data adjusting circuit 33 generates a data selecting signal S₃₃. The data adjusting circuit 33 can be a level shifter. Thereby, the data adjusting circuit 33 can adjust the level of the data control signal S₃₁.

The data selecting circuit 35 is coupled to the power circuit 70 and the data adjusting circuit 33. Thereby, after the data selecting circuit 35 receives the power signal S_{H}, the reference signal S_{L}, and the data selecting signal S₃₃, it selects the power signal S_{H} or the reference signal S_{L} according to the data selecting signal S₃₃. Hence, the data selecting circuit 35 outputs the data signals S_{D} to the pixels 10 according to the power signal S_{H} or the reference signal S_{L}. Then, the data driving circuit 30 outputs the data signals S_{D} according to the data timing signal DT. The data selecting circuit 35 can be a multiplexer; the reference signal S_{L} can be generated by the power circuit 70 or be the ground level of the circuit.

Please refer to FIG. 1 again. The scan driving circuit 50 is coupled to the pixels 10 for driving them. The scan driving circuit 50 is used for controlling turn-on or turn-off of the pixels 10. Thereby, in the turn-on state, the pixels 10 can change the display states. The scan driving circuit 50 according to the present invention comprises a scan storage unit 51 and a scan selecting circuit 53. The scan storage unit 51 is coupled to the timing controller 60 and receives the scan timing signal ST. The scan storage unit 51 generates a scan selecting signal S₅₁ according to the scan timing signal ST. Thereby, after the scan selecting circuit 53 receives a turn-on signal V_{H}, a turn-off signal V_{L}, and the scan selecting signal S₅₁, the scan selecting circuit 53 selects the turn-on signal V_{H} or the turn-off signal V_{L} according to the scan selecting signal S₅₁. Then the scan selecting circuit 53 outputs a plurality of scan signals S_{S} to the pixels 10, respectively, according to the turn-on signal V_{H} or the turn-off signal V_{L}. Consequently, the scan driving circuit 50 outputs the scan signals S_{S} the according to the scan timing signal ST. The scan storage unit 51 can be a shift register; the scan selecting circuit 53 can be a multiplexer.

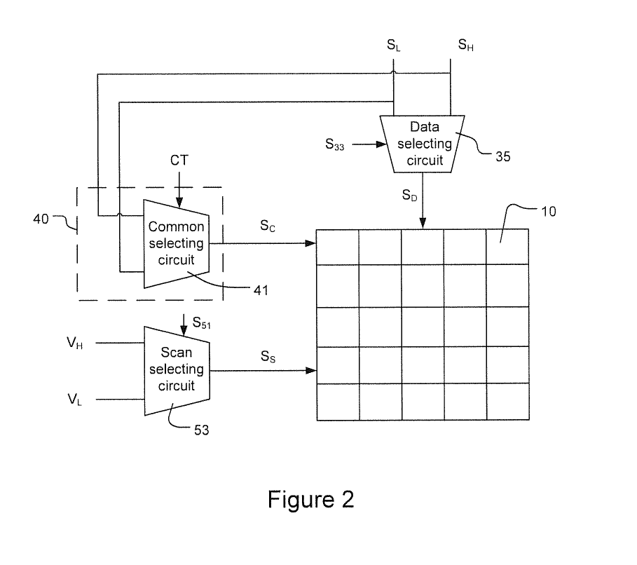

Please refer to FIG. 2, which shows a block diagram of the data selecting circuit 35, the common selecting circuit 41, and the scan selecting circuit 53 according to an embodiment of the present invention. As shown in this figure, like the data driving circuit 30 and the scan driving circuit 50, the common driving circuit 40 according to the present invention also includes a selecting circuit, namely, the common selecting circuit 41 shown in FIG. 2. The common selecting circuit 41 is coupled to the power circuit 70 and the timing controller 60 for receiving the power signal S_{H}, the reference signal S_{L}, and the common timing signal CT. The common selecting circuit 41 selects the power signal S_{H} or the reference signal S_{L} according to the common timing signal CT. Thereby, the common selecting circuit 41 outputs the common signal S_{C} to the pixels 10 according to the power signal S_{H} or the reference signal S_{L}. Accordingly, the common driving circuit 40 outputs the common signal S_{C} according to the common timing signal CT. Likewise, the common selecting circuit 41 can be a multiplexer.

Please refer again to FIGS. 1 and 2. After the display is turned on, the scan driving circuit 50 scans the pixels 10 for controlling the turn-on or turn-off of the pixels 10. In other words, when the display state of the pixels 10 is to be changed, the scan driving circuit 50 outputs the scan signals S_{S} to the pixels 10, respectively, for turning on the pixels 10. Hence, the pixels 10 can use the data signals S_{D} and the common signal S_{C} for displaying a frame. For example, when a black-and-white display needs to change its display state, the data driving circuit 30 outputs the data signals S_{D} according to the power signal S_{H}. The common driving circuit 40 outputs the common signal S_{C} according to the reference signal S_{L}. Then the pixels 10 receive the data signals S_{D}, for example, high-level signals, generated according to the power signal S_{H}, and the common signal S_{C}, for example, a low-level signal, generated according to the reference signal S_{L}.

Contrarily, when the data driving circuit 30 outputs the data signals S_{D} according to the reference signal S_{L}, and the common driving circuit 40 outputs the common signal S_{C} according to the power signal S_{H}, the pixels 10 receive the data signals S_{D}, for example, low-level signals, generated according to the reference signal S_{L}, and receive ( [symbol] the pixels 10 [symbol] receive [symbol] ) the common signal S_{C}, for example, high-level signal, generated according to the power signal S_{H}. In addition, the pixels 10 can also receive the data signals S_{D} and the common signal S_{C} with identical level. That is to say, the present invention does not limit the levels of the data signals S_{D} and the common signal S_{C} in a scan cycle to be fixed to the power signal S_{H} or the reference signal S_{L}. For example, when the common signal S_{C} is high (the power signal S_{H}) the data signal S_{D} output to the first scan line G_{N} can be low (the reference signal S_{L}) and the data signal S_{D} output to the N-th scan line G_{N} can be high (the power signal S_{H}). Thereby, the pixels 10 can display a black frame, a white frame, or a black-and-white frame according to the changes in the levels of the data signals S_{D} and the common signal S_{C}.

The data signals S_{D} are output by the data selecting circuit 35, while the common signal S_{C} is output by the common selecting circuit 41. Besides, the data selecting circuit 35 and the common selecting circuit 41 determine the data signals S_{D} and the common signal S_{C} according to the power signal S_{H} and the reference signal S_{L}. Thereby, when the pixels 10 need to change their display states, the display driving circuit 20 needs to generate only four power sources, including the power signal S_{H}, the reference signal S_{L}, the turn-on signal V_{H}, and the turn-off signal V_{L}. Nonetheless, when the reference signal is not necessarily generated by the power circuit 70 but connected to the ground level of the circuit, the display driving circuit 20 needs to generate only three power sources, including the power signal S_{H}, the turn-on signal V_{H}, and the turn-off signal V_{L} as the pixels 10 need to change the display states.

Moreover, after the display states of the pixels 10 is changed and the scan driving circuit 50 turns off the pixels 10, the display driving circuit 20 according to the present invention needs to generate only two power sources, including the power signal S_{H} and the turn-off signal V_{L}. Accordingly, the display driving circuit 20 according to the present invention can reduce power consumption significantly and thus achieving a power-saving design for the display driving circuit 20.

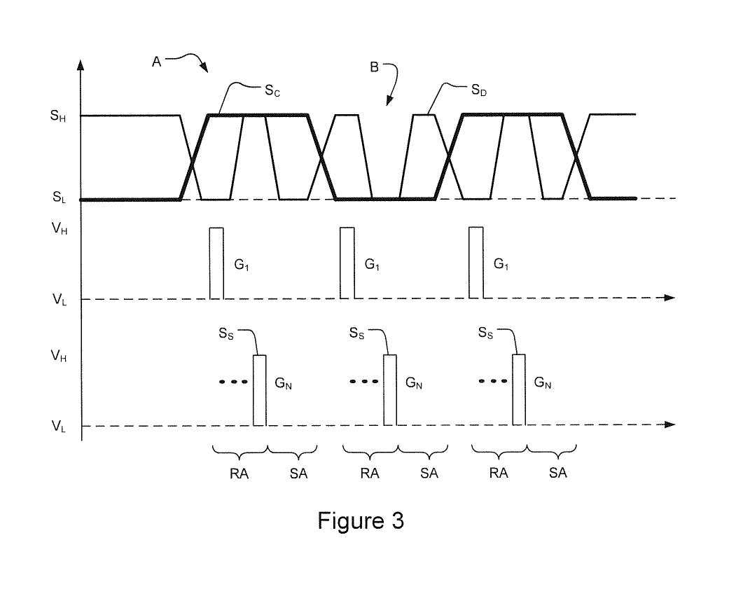

Please refer to FIG. 3, which shows the first waveforms of the data signal S_{D} and the common signal S_{C} according to the present invention. As shown in the figure, the scan selecting circuit 53 scans a plurality of scan lines G₁ . . . G_{N} in the refresh period. When the common selecting circuit 41 outputs the high-level common signal Sc, the data selecting circuit 35 output the high- or low-level data signal S_{D} according to the data selecting signal S₃₃. For example, as the waveform A in FIG. 3 shows, when the common selecting circuit 41 outputs the high-level common signal S_{C}, the data selecting circuit 35 outputs the low-level data signal S_{D} to the first scan line G₁ according to the data selecting signal S₃₃, and the data selecting circuit 35 outputs the high-level data signal S_{D} to the N-th scan line G_{N} according to the data selecting signal S₃₃.

For another example, as the waveform B in FIG. 3 shows, when the common selecting circuit 41 outputs the low-level common signal S_{C}, the data selecting circuit 35 outputs the high-level data signal S_{D} to the first scan line G₁ according to the data selecting signal S₃₃, and the data selecting circuit 35 outputs the low-level data signal S_{D} to the N-th scan line G_{N} according to the data selecting signal S₃₃. Nonetheless, in the waiting period SA, the scan selecting circuit 53 does not scan the plurality of scan lines G₁ . . . G_{N}. Thereby, in the waiting period, the display driving circuit 20 only needs to generate three power sources, including the power signal S_{H}, the reference signal S_{L}, and the turn-off signal V_{L}. Furthermore, if the reference signal S_{L} is the ground level of the circuit, then in the waiting period, the display driving circuit 20 only needs to generate two power sources, including the power signal S_{H} and the turn-off signal V_{L}.

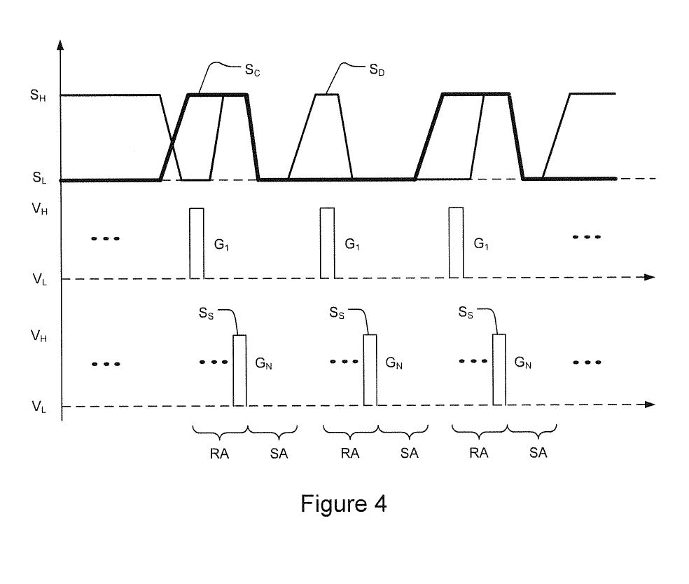

Please refer to FIG. 4, which shows the second waveforms of the data signal S_{D} and the common signal S_{C} according to the present invention. As shown in the figure, the difference between the waveforms in FIG. 4 and those in FIG. 3 is that the display circuit 20 does not generate the power signal S_{H} in the waiting period SA. In other words, the display driving circuit 20 needs to generate only one power source, the turn-off signal V_{L}, in the waiting period SA.

According to the above description, the display driving circuit 20 according to the present invention requires no gamma circuit. In addition, in the data driving circuit 30, the data selecting circuit 35 can replace the digital-to-analog converter and the operational amplifier. Moreover, the preferred application of the display driving circuit 20 according to the present invention is electronic tags, labels for goods shelves, smart watches, and other products used for displaying product information. Besides, the frame frequency for displaying frames is preferably below 30 Hz.

To sum up, the display driving circuit according to the present invention comprises a power circuit, a data driving circuit, a common driving circuit, and a scan driving circuit. The power driving circuit generates a power signal. The data driving circuit is coupled to the power circuit, and outputs a plurality of data signals to a plurality of pixels, respectively, according to the power signal or a reference signal. The common driving circuit is coupled to the power circuit, and outputs a common signal to the plurality of pixels according to the power signal or the reference signal. The scan driving circuit controls the plurality of pixels to receiver the plurality of data signals, respectively, for displaying a frame.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A display driving circuit, comprising:
a power circuit, generating a power signal;
a data driving circuit, coupled to said power circuit, outputting a plurality of data signals to a plurality of pixels, respectively, according to said power signal or a reference signal;
a common driving circuit, coupled to said power circuit, outputting a common signal to said pixels according to said power signal or said reference signal; and
a scan driving circuit, controlling said pixels to receive said data signals, respectively, for displaying a frame.

2. The display driving circuit of claim 1, wherein said data driving circuit, said common driving circuit, and said scan driving circuit are coupled to said pixels, said pixels receive said common signal generated according to said reference signal when a plurality of scan signals of said scan driving circuit turn on said pixels and said pixels receive said data signals generated according to said power signal.

3. The display driving circuit of claim 1, wherein said pixels receive said common signal generated according to said power signal when a plurality of scan signals of said scan driving circuit turn on said pixels and said pixels receive said data signals generated according to said reference signal.

4. The display driving circuit of claim 1, wherein said power circuit turns off said power signal when said data driving circuit outputs said data signals according to said power signal, said common driving circuit outputs said common signal according to said reference signal, and a plurality of scan signals of said scan driving circuit turn off said pixels.

5. The display driving circuit of claim 1, wherein said power circuit turns off said power signal when said data driving circuit outputs said data signals according to said reference signal, said common driving circuit outputs said common signal according to said power signal, and a plurality of scan signals of said scan driving circuit turn off said pixels.

6. The display driving circuit of claim 1, and further comprising a timing controller, outputting a data timing signal, a common timing signal, a scan timing signal, and a power timing signal for controlling said data driving circuit, said common driving circuit, said scan driving circuit, and said power circuit to display said frame.

7. The display driving circuit of claim 6, wherein said data driving circuit comprises:
a data storage unit, coupled to said timing controller, and storing a display data according to said data timing signal for generating a data control signal;
a data adjusting circuit, coupled to said data storage unit, receiving said data control signal, and adjusting said data control signal for generating a data selecting signal; and
a data selecting circuit, coupled to said power circuit and said data adjusting circuit, receiving said power signal, said reference signal, and said data selecting signal, and selecting said power signal or said reference signal according to said data selecting signal for outputting said data signals to said pixels, respectively.

8. The display driving circuit of claim 6, wherein said common driving circuit comprises a common selecting circuit, coupled to said power circuit and said timing controller, receiving said power signal, said reference signal, and said common timing signal, and selecting said power signal or said reference signal according to said common timing signal for outputting said common signal to said pixels.

9. The display driving circuit of claim 6, wherein said scan driving circuit comprises:
a scan driving unit, coupled to said timing controller, and generating a scan selecting signal according to said scan timing signal; and
a scan selecting circuit, coupled to said power circuit and said scan storage unit, receiving a turn-on signal, a turn-off signal, and said scan selecting signal, and selecting said turn-on signal or said turn-off signal according to said scan selecting signal for outputting a plurality of scan signals to said pixels, respectively.

10. The display driving circuit of claim 1, wherein the frame frequency of said frame is below 30 Hz.

11. The display driving circuit of claim 1, wherein said reference signal is a ground level.
